(19) United States
(12) Patent Application Publication
(10) Pub. No.: US 2026/0320330 A1
(43) Pub. Date: Oct. 15, 2026

(54) IMAGE PROCESSING APPARATUS CONTROL METHOD AND IMAGE PROCESSING APPARATUS

(71) Applicant: KYOCERA Document Solutions Inc., Osaka-shi (JP)

(72) Inventor: Shinji Nakatsuka, Osaka (JP)

(21) Appl. No.: 19/467,509

(22) Filed: Feb. 2, 2026

(30) Foreign Application Priority Data
Feb. 21, 2025 (JP) 2025-026438

(51) Int. Cl. G06K 15/02; B41J 11/00; B41J 29/393; G06T 7/00

(52) U.S. Cl. CPC G06K 15/027; B41J 11/0095; B41J 29/393; G06K 15/1872; G06T 7/0004; B41J 2029/3935; G06T 2207/30144; G06T 2207/30168

(57) ABSTRACT

A unit support mechanism is capable of adjusting a unit distance which is a distance between a conveying path and a contact image sensor unit. A filter processing device executes sharpening filter processing on read image data. A control device causes, before a print job is executed, the unit support mechanism to execute an operation of adjusting the unit distance to a representative distance corresponding to representative sheet characteristics. The control device specifies, every time the sharpening filter processing is executed, a target parameter corresponding to a combination of target sheet characteristics and the representative distance from among a plurality of candidate parameters, and sets the target parameter in the filter processing device.

### INCORPORATION BY REFERENCE

This application is based upon and claims the benefit of priority from the corresponding Japanese Patent Application No. 2025-026438 filed on Feb. 21, 2025, the entire contents of which are incorporated herein by reference.

### BACKGROUND

The present disclosure relates to an image processing apparatus control method for controlling a mechanism for adjusting a position of a contact image sensor unit which reads a print image, and an image processing apparatus.

The image processing apparatus may include a printing device and an image reading device. The printing device conveys a sheet and forms an image on the conveyed sheet. The image reading device reads the image formed on the sheet.

For example, it is known that the image processing apparatus corrects a position, size, and/or the like in image formation by the printing device based on a read image obtained by the image reading device.

Furthermore, it is also known that the image processing apparatus includes a mechanism which movably supports the image reading device and is capable of adjusting a distance between a conveying path of the sheet and the image reading device.

### SUMMARY

An image processing apparatus control method according to an aspect of the present disclosure is a method of controlling an image processing apparatus. The image processing apparatus includes a printing device, a contact image sensor unit, a unit support mechanism, and a filter processing device. The printing device executes a print job for conveying each of a plurality of sheets along a conveying path and forming an image on each of the plurality of sheets in a first area on the conveying path. The contact image sensor unit is arranged along a second area on a downstream side of the first area on the conveying path in a sheet conveying direction, and reads the image formed on each of the plurality of sheets. The unit support mechanism movably supports the contact image sensor unit and is capable of adjusting a unit distance which is a distance between the second area of the conveying path and the contact image sensor unit. The filter processing device executes sharpening filter processing on read image data obtained by the contact image sensor unit, and outputs the processed image data. The image processing apparatus control method includes acquiring, by a control device, first correspondence data and second correspondence data. The first correspondence data represents a correspondence relationship between each of a plurality of candidate characteristics representing sheet characteristics and each of a plurality of corresponding distances corresponding to one of a plurality of candidate distances which are candidates for the unit distance. The second correspondence data represents a correspondence relationship between each of a plurality of combinations of the plurality of candidate characteristics and the plurality of candidate distances and each of a plurality of corresponding parameters corresponding to one of a plurality of candidate parameters which are candidates for a filter parameter. The image processing apparatus control method further includes acquiring, by the control device, data of a plurality of job sheet characteristics representing the sheet characteristics of the plurality of sheets corresponding to the print job. The image processing apparatus control method further includes specifying, by the control device, representative sheet characteristics as one of the plurality of job sheet characteristics. The image processing apparatus control method further includes causing, by the control device, before the print job is executed, the unit support mechanism to execute an operation of adjusting the unit distance to a representative distance corresponding to the representative sheet characteristics out of the plurality of corresponding distances in the first correspondence data. The image processing apparatus control method further includes specifying, by the control device, every time the sharpening filter processing is executed on the read image data obtained for each of the plurality of sheets conveyed in the print job, a target parameter corresponding to a combination of target sheet characteristics corresponding to each of the plurality of sheets out of the plurality of job sheet characteristics and the representative distance, from among the plurality of candidate parameters in the second correspondence data, and setting the target parameter in the filter processing device as a parameter to be used for the sharpening filter processing.

An image processing apparatus according to another aspect of the present disclosure includes the printing device, the contact image sensor unit, the unit support mechanism, the filter processing device, and the control device which realizes the image processing apparatus control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image processing apparatus according to an embodiment;

FIG. 2 is a schematic plan view of a CIS unit in the image processing apparatus according to the embodiment;

FIG. 3 is a configuration diagram of the CIS unit in the image processing apparatus according to the embodiment;

FIG. 4 is a block diagram showing the configuration of a control device in the image processing apparatus according to the embodiment;

FIG. 5 is a configuration diagram of a unit support mechanism in the image processing apparatus according to the embodiment;

FIG. 6 is a flowchart showing exemplary procedures of registration data setting processing in the image processing apparatus according to the embodiment;

FIG. 7 is a flowchart showing exemplary procedures of print job control in the image processing apparatus according to the embodiment;

FIG. 8 is a flowchart showing exemplary procedures of registration data update processing in the image processing apparatus according to the embodiment; and

FIG. 9 is a diagram showing an example of a configuration of registration data in the image processing apparatus according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

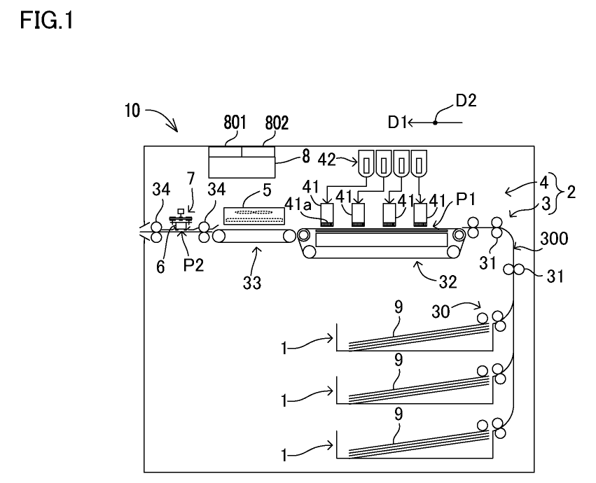

An image processing apparatus 10 according to the embodiment is capable of executing a print job and image reading processing. The print job is processing of conveying each of a plurality of sheets 9 along a conveying path 300 and forming an image on each of the sheets 9 in a first area P1 on the conveying path 300 (see FIG. 1).

In the image processing apparatus 10, the image reading processing is processing of reading an image formed on each of the sheets 9 in a second area P2 on a downstream side of the first area P1 on the conveying path 300 in a sheet conveying direction (see FIG. 1).

### Configuration of image processing apparatus 10

The image processing apparatus 10 includes a sheet storing portion 1, a printing device 2, a drying device 5, a CIS unit 6, and the like (see FIG. 1). The CIS unit 6 is a contact image sensor unit.

The printing device 2 executes the print job. The printing device 2 includes a sheet conveying device 3 and an image forming portion 4.

The sheet storing portion 1 stores a plurality of sheets 9. The sheet conveying device 3 includes a feeding mechanism 30 that feeds each of the plurality of sheets 9 from the sheet storing portion 1 to the conveying path 300.

The sheet conveying device 3 further includes a plurality of first conveying roller pairs 31, a first belt conveying device 32, a second belt conveying device 33, and a plurality of second conveying roller pairs 34. The plurality of first conveying roller pairs 31, the first belt conveying device 32, the second belt conveying device 33, and the plurality of second conveying roller pairs 34 convey each of the sheets 9 along the conveying path 300.

The first conveying roller pair 31 conveys each of the sheets 9 fed by the feeding mechanism 30 to the first belt conveying device 32. The first belt conveying device 32 conveys each of the sheets 9 in the first area P1 of the conveying path 300, and further conveys each of the sheets 9 to the second belt conveying device 33.

The second belt conveying device 33 takes over the conveyance of each of the sheets 9 from the first belt conveying device 32, and further conveys each of the sheets 9 to the second area P2 of the conveying path 300. The second area P2 is an area on a downstream side of the first area P1 on the conveying path 300 in the sheet conveying direction.

The second conveying roller pair 34 conveys each of the sheets 9 along a portion of the conveying path 300 that includes the second area P2, and further conveys each of the sheets 9 from the conveying path 300 to a subsequent portion of the conveying path. For example, the subsequent portion of the conveying path is a post-processing device that performs post-processing on each of the sheets 9, a discharge tray, and/or the like.

The image forming portion 4 forms an image on each of the sheets 9 conveyed by the first belt conveying device 32. In the present embodiment, the image forming portion 4 forms an image on each of the sheets 9 by an inkjet method. In this case, the image forming portion 4 includes a plurality of inkjet heads 41 respectively corresponding to a plurality of developing colors.

Each of the inkjet heads 41 forms an ink image on each of the sheets 9 by ejecting ink droplets onto each of the sheets 9. The image forming portion 4 also includes an ink supply device 42 that supplies ink to each of the inkjet heads 41.

It is noted that the image forming portion 4 may be a device that forms an image on each of the sheets 9 by a method other than the inkjet method, such as electrophotography.

The drying device 5 dries the ink by blowing hot air onto the ink image formed on each of the sheets 9 conveyed by the second belt conveying device 33.

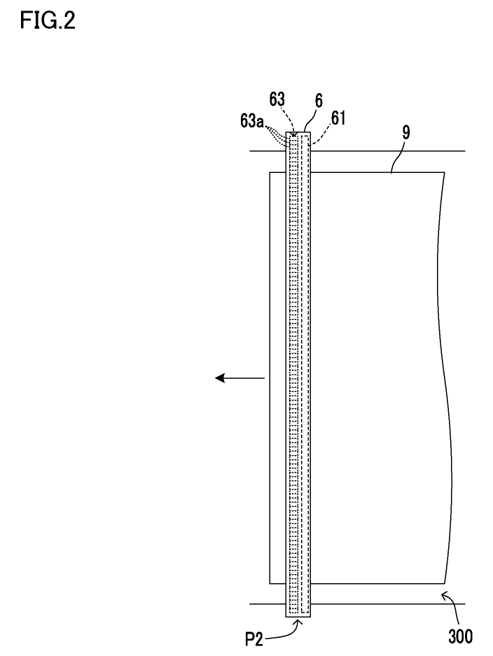

The CIS unit 6 is arranged along the second area P2 of the conveying path 300, and reads the image formed on each of the sheets 9. The CIS unit 6 is arranged along a main scanning direction that intersects with the sheet conveying direction (see FIG. 2).

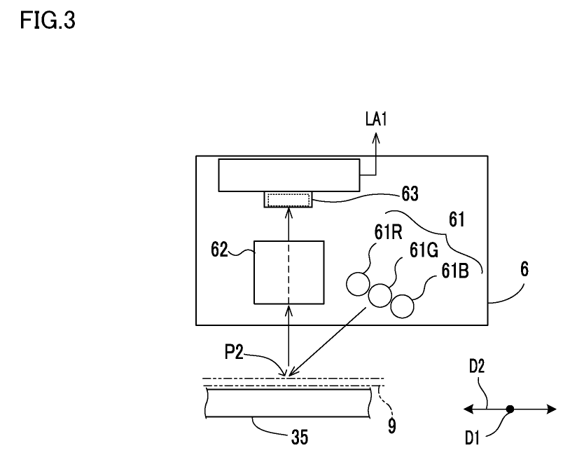

The CIS unit 6 includes a light-emitting portion 61 that emits light toward the second area P2 and a line sensor 63 that receives light reflected by a surface of each of the sheets 9 and detects an amount of received light (see FIG. 3). The CIS unit 6 further includes a lens 62 that collects the reflected light on the line sensor 63 (see FIG. 3).

The line sensor 63 is a CMOS image sensor including a plurality of photoelectric conversion elements 63a arrayed along the main scanning direction (see FIG. 2). The light-emitting portion 61 includes a red light source 61R, a green light source 61G, and a blue light source 61B (see FIG. 3).

The CIS unit 6 outputs red, green, and blue line image signals LA1 (see FIG. 3).

The image processing apparatus 10 also includes an operation device 801, a display device 802, a control device 8, and the like (see FIG. 1).

The operation device 801 detects operations by a person. For example, the operation device 801 includes a plurality of operation buttons and/or a touch panel. The display device 802 is capable of displaying various types of information. For example, the display device 802 is a panel display device such as a liquid crystal display panel.

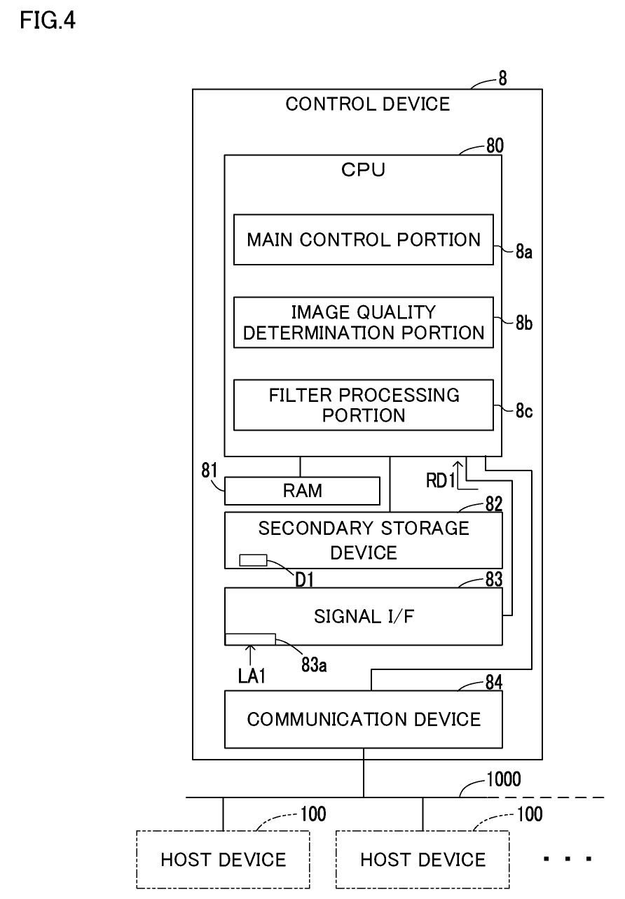

As shown in FIG. 4, the control device 8 includes a CPU (Central Processing Unit) 80, a RAM (Random Access Memory) 81, a secondary storage device 82, a signal interface 83, a communication device 84, and the like.

The CPU 80 executes computer programs to execute various types of control and data processing. The RAM 81 temporarily stores the computer programs to be executed by the CPU 80 and various types of data.

The secondary storage device 82 is a computer-readable non-volatile storage device. The secondary storage device 82 stores the computer programs to be executed by the CPU 80 and various types of data. For example, one or both of a flash memory and a hard disk drive is/are used as the secondary storage device 82.

The signal interface 83 converts detection signals of various sensors into digital detection data, and transmits the detection data to the CPU 80. Furthermore, the signal interface 83 converts control commands output from the CPU 80 into control signals, and transmits the control signals to control target equipment.

The signal interface 83 includes an AFE (Analog Front End) 83a that converts analog line image signals LA1 sequentially output by the CIS unit 6 into digital read image data RD1 (see FIG. 4). The read image data RD1 is transmitted to the CPU 80.

The communication device 84 communicates with other devices such as a host device 100 through a network 1000. The CPU 80 communicates with other devices through the communication device 84. The host device 100 is an information processing apparatus that requests the image processing apparatus 10 to perform the print processing.

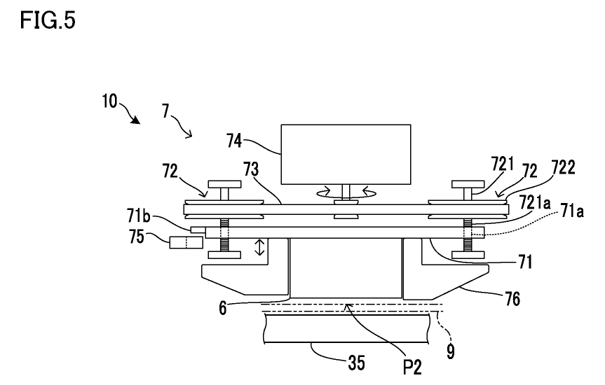

The image processing apparatus 10 further includes a unit support mechanism 7 that movably supports the CIS unit 6 (see FIGS. 1 and 5). The unit support mechanism 7 is capable of adjusting a unit distance which is a distance between the second area P2 of the conveying path 300 and the CIS unit 6.

The unit support mechanism 7 includes a unit support member 71, an operation conversion mechanism 72, a motor 74, and a base point detection sensor 75.

The unit support member 71 supports the CIS unit 6. The operation conversion mechanism 72 converts a rotational operation of an output shaft of the motor 74 into an operation of a linear movement of the unit support member 71. The linear movement operation of the unit support member 71 is an operation of approaching the second area P2 of the conveying path 300 or moving away from the second area P2.

In the example shown in FIG. 5, the operation conversion mechanism 72 includes a plurality of drive shafts 721, a plurality of pulleys 722, and an endless drive belt 73. The plurality of drive shafts 721 are each supported rotatably. Each of the drive shafts 721 is formed with a screw 721a.

On the other hand, the unit support member 71 is formed with a plurality of screw holes 71a that engage with the screws 721a of the plurality of drive shafts 721.

The plurality of pulleys 722 are formed integrally with the plurality of drive shafts 721. The drive belt 73 is stretched between the plurality of pulleys 722 and an output shaft of the motor 74. When the motor 74 is operated, the plurality of drive shafts 721 rotate and the unit support member 71 moves.

The base point detection sensor 75 detects a to-be-detected portion 71b formed on the unit support member 71. The base point detection sensor 75 detects that the unit support member 71 is positioned at a predetermined base point position.

For example, the base point detection sensor 75 is a transmission-type photosensor, a reflection-type photosensor, or the like. The unit distance is adjusted by a rotation amount of the motor 74 from a time point when the to-be-detected portion 71b is detected by the base point detection sensor 75.

It is noted that the operation conversion mechanism 72 may be another mechanism that converts the rotational operation of the output shaft of the motor 74 into the linear movement operation of the unit support member 71. For example, a cam mechanism may be adopted as the operation conversion mechanism 72.

In the example shown in FIG. 5, the unit support mechanism 7 also includes a sheet guide 76 formed integrally with the unit support member 71. The sheet guide 76 guides each of the conveyed sheets 9 to the second area P2 of the conveying path 300.

In the present embodiment, the sheet conveying device 3 includes a conveyance guide plate 35 arranged opposed to the CIS unit 6 (see FIGS. 3 and 5). The second area P2 of the conveying path 300 is formed between the CIS unit 6 and the conveyance guide plate 35.

The CPU 80 includes a plurality of processing modules that are realized by executing the computer programs. The plurality of processing modules include a main control portion 8a, an image quality determination portion 8b, and the like (see FIG. 4).

The main control portion 8a controls the printing device 2 to control the conveyance of each of the sheets 9 and the formation of an image on each of the sheets 9. Furthermore, the main control portion 8a operates the drying device 5 when an image is formed on each of the sheets 9.

Furthermore, the main control portion 8a controls the motor 74 of the unit support mechanism 7 to cause the unit support mechanism 7 to execute an operation of adjusting the unit distance.

In the present embodiment, the main control portion 8a rotates the motor 74 in a first rotation direction until the to-be-detected portion 71b is detected by the base point detection sensor 75, and then stops the motor 74. Furthermore, the main control portion 8a controls the rotation amount of the motor 74 in a second rotation direction in accordance with a target value of the unit distance.

The image quality determination portion 8b determines quality of an output image formed on each of the sheets 9 based on the read image data RD1 or image data obtained by performing preprocessing on the read image data RD1. For example, the image quality determination portion 8b determines output image quality, which is some or all of a density, position, and size of the output image.

The main control portion 8a corrects print parameters of the printing device 2 in accordance with a result of the determination on the output image quality.

It is noted that a part or all of the processing executed by the CPU 80 may be executed by a DSP (Digital Signal Processor), a SoC (System on a Chip), and/or the like. Each of the CPU 80, the DSP, and the SoC is an example of a processor.

A distance between the surface of each of the sheets 9 being conveyed and the CIS unit 6 varies depending on the thickness of each of the sheets 9. When the CIS unit 6 is adopted as an image reading device, the change in the distance between the surface of each of the sheets 9 and the CIS unit 6 significantly affects blurring of a read image of the CIS unit 6.

When executing the print job, the image processing apparatus 10 forms images successively on the plurality of sheets 9. In the print job, a plurality of types of sheets 9 having different sheet characteristics such as a thickness or a surface processed state may be used.

Meanwhile, adjusting the position of the CIS unit 6 in accordance with the sheet characteristics of each of the sheets 9 during the print job leads to a decrease in the execution speed of the print job.

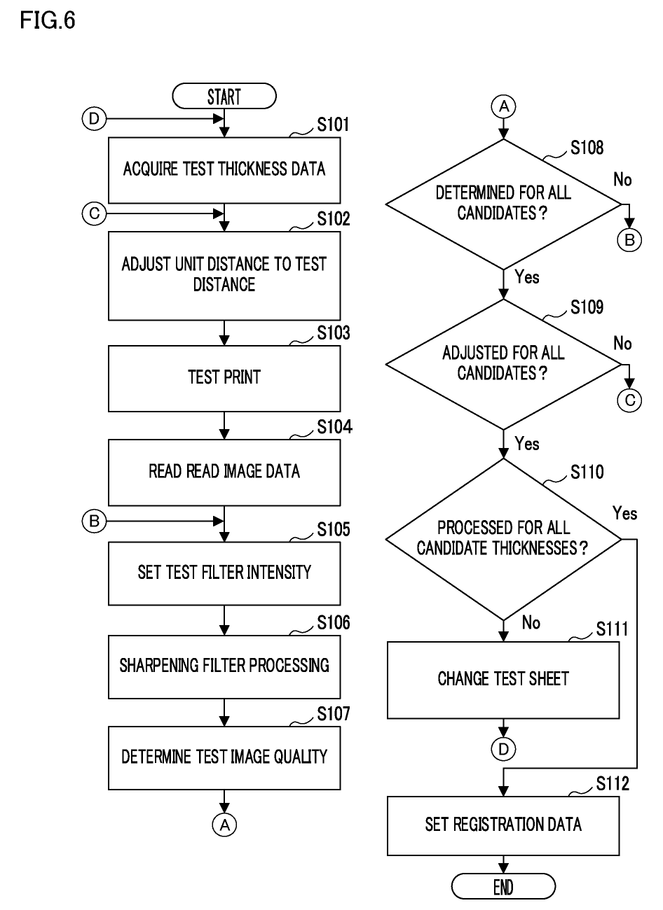

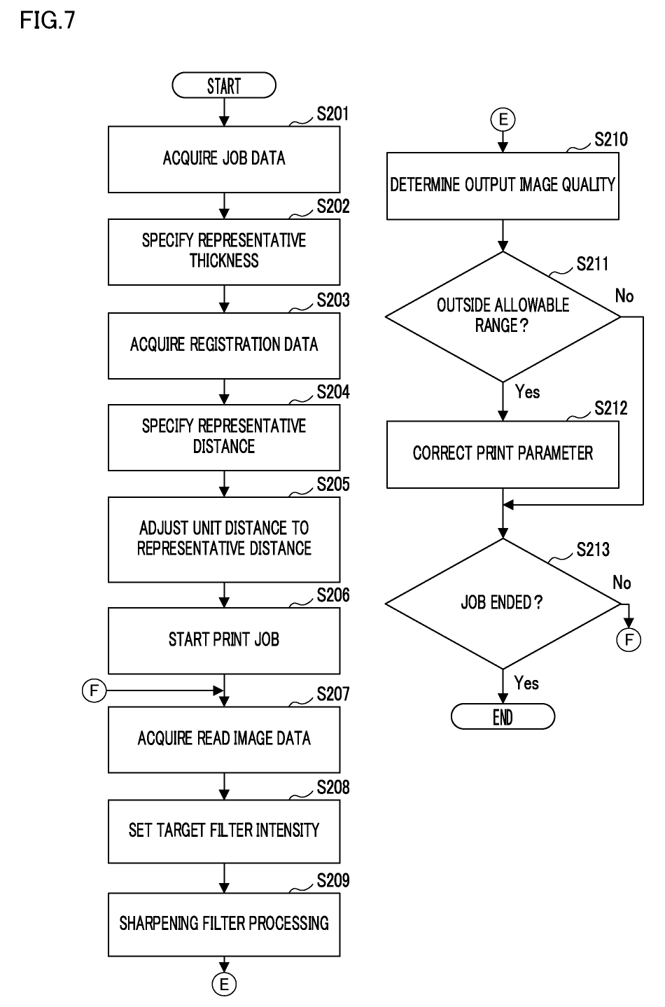

The image processing apparatus 10 executes the registration data setting processing and print job control (see FIGS. 6 and 7), which will be described later. Thus, even when the plurality of types of sheets 9 having different sheet characteristics are used in the print job, the image processing apparatus 10 can avoid lowering of the image quality of the read image of the CIS unit 6 while maintaining the execution speed of the print job.

The plurality of processing modules in the CPU 80 further include a filter processing portion 8c (see FIG. 4). The filter processing portion 8c executes sharpening filter processing on the read image data RD1 obtained by the CIS unit 6, and outputs the processed image data.

The filter processing portion 8c of the CPU 80 is an example of a filter processing device that executes the sharpening filter processing. It is noted that the filter processing device may alternatively be realized by an ASIC (Application Specific Integrated Circuit), a DSP, a SoC, and/or the like.

### Registration data setting processing

Hereinafter, exemplary procedures of the registration data setting processing will be described with reference to the flowchart shown in FIG. 6.

The CPU 80 executes the registration data setting processing when a predetermined registration data setting operation is detected by the operation device 801. The registration data setting processing is an example of processing for realizing an image processing apparatus control method. The image processing apparatus control method is a method of controlling the image processing apparatus 10.

In descriptions below, the thickness of the plurality of sheets 9 stored in the sheet storing portion 1 when the registration data setting processing is executed will be referred to as a test thickness. The test thickness is one of a plurality of predetermined candidate thicknesses. The plurality of candidate thicknesses are each a candidate for the sheet thickness of each of the sheets 9. The plurality of candidate thicknesses are an example of a plurality of candidate characteristics that represent the sheet characteristics.

The plurality of sheets 9 stored in the sheet storing portion 1 when the registration data setting processing is executed will be referred to as a plurality of test sheets.

The registration data setting operation is performed in a state where the plurality of test sheets of the same thickness are stored in the sheet storing portion 1 and test thickness data representing the test thickness is input in advance via the operation device 801. The input test thickness data is stored in the secondary storage device 82.

In descriptions below, S101, S102, ... represent identification codes of a plurality of steps in the registration data setting processing. In the registration data setting processing, processing of Step S101 is executed first.

### Step S101

In Step S101, the main control portion 8a acquires the test thickness data from the secondary storage device 82. After executing the processing of Step S101, the main control portion 8a shifts the processing to Step S102.

It is noted that the thickness of each of the sheets 9 is an example of the sheet characteristics. The test thickness is an example of test sheet characteristics representing the sheet characteristics of the plurality of test sheets having the same characteristics. The test thickness data is an example of data of the test sheet characteristics.

### Step S102

In Step S102, the main control portion 8a selects one test distance from a plurality of predetermined candidate distances, and causes the unit support mechanism 7 to execute an operation of adjusting the unit distance to the test distance. The plurality of candidate distances are candidates for the unit distance.

After executing the processing of Step S102, the main control portion 8a shifts the processing to Step S103.

### Step S103

In Step S103, the main control portion 8a causes the printing device 2 to execute test print processing.

The test print processing is processing of conveying one of the plurality of test sheets along the conveying path 300 and forming a test image on the conveyed sheet 9. For example, the test image includes an image of a plurality of thin lines arrayed at predetermined intervals.

After executing the processing of Step S103, the main control portion 8a shifts the processing to Step S104.

### Step S104

In Step S104, the main control portion 8a causes the filter processing portion 8c to execute processing of acquiring the read image data RD1 for the test image obtained by the CIS unit 6.

After executing the processing of Step S104, the main control portion 8a shifts the processing to Step S105.

### Step S105

In Step S105, the main control portion 8a selects one test filter intensity from a plurality of predetermined candidate filter intensities, and sets the test filter intensity in the filter processing portion 8c.

The plurality of candidate filter intensities are an example of a plurality of candidate parameters representing filter parameters used in the sharpening filter processing.

After executing the processing of Step S105, the main control portion 8a shifts the processing to Step S106.

### Step S106

In Step S106, the main control portion 8a causes the filter processing portion 8c to execute the sharpening filter processing on the read image data RD1 using the test filter intensity. Thus, the processed image data corresponding to the test filter intensity is obtained.

After executing the processing of Step S106, the main control portion 8a shifts the processing to Step S107.

### Step S107

In Step S107, the image quality determination portion 8b determines the test image quality of the processed image data obtained by the sharpening filter processing that uses the test filter intensity.

For example, the image quality determination portion 8b compares one or both of the density and area of the test image represented by the processed image data with a target level, to derive a determination value for the test image quality.

After executing the processing of Step S107, the image quality determination portion 8b shifts the processing to Step S108.

### Step S108

In Step S108, the main control portion 8a selects the next processing in accordance with whether or not the determination on the test image quality has been performed for all of the plurality of candidate filter intensities.

When the determination on the test image quality has not been performed for some of the plurality of candidate filter intensities, the main control portion 8a shifts the processing to Step S105. Thus, a new test filter intensity is selected from the plurality of candidate filter intensities, and the processing of Step S105 and subsequent steps that corresponds to the new test filter intensity is executed.

On the other hand, when the determination on the test image quality has been performed for all of the plurality of candidate filter intensities, the main control portion 8a shifts the processing to Step S109.

### Step S109

In Step S109, the main control portion 8a selects the next processing in accordance with whether or not all of the plurality of candidate distances have been selected as the test distance and the adjustment of the unit distance to the test distance has been performed.

When the adjustment of the unit distance has not been performed for some of the plurality of candidate distances, the main control portion 8a shifts the processing to Step S102. Thus, a new test distance is selected from the plurality of candidate distances, and the processing of Step S102 and subsequent steps that corresponds to the new test distance is executed.

On the other hand, when the adjustment of the unit distance has been performed for all of the plurality of candidate distances, the main control portion 8a shifts the processing to Step S110.

As described above, the CPU 80 causes the printing device 2 to execute the processing of conveying each of the plurality of test sheets along the conveying path 300 and forming the test image on each of the plurality of test sheets (see Step S103).

Furthermore, the CPU 80 causes the unit support mechanism 7 to execute the processing of adjusting the unit distance to the test distance sequentially selected from the plurality of candidate distances every time each of the plurality of test sheets is conveyed (see Step S102).

Furthermore, the CPU 80 causes the filter processing portion 8c to execute the sharpening filter processing that uses each of the plurality of candidate parameters with respect to the read image data RD1 obtained for each of the plurality of test sheets (see Step S105 to Step S106).

Furthermore, the CPU 80 determines the test image quality for the processed image data obtained by the sharpening filter processing that uses each of the plurality of candidate parameters (see Step S107).

### Step S110

In Step S110, the main control portion 8a selects the next processing in accordance with whether or not the processing of Step S101 to Step S109 has been performed for all of the plurality of candidate thicknesses.

When the processing of Step S101 to Step S109 has not been performed for some of the plurality of candidate thicknesses, the main control portion 8a shifts the processing to Step S111.

On the other hand, when the processing of Step S101 to Step S109 has been performed for all of the plurality of candidate thicknesses, the main control portion 8a shifts the processing to Step S112.

### Step S111

In Step S111, the main control portion 8a executes processing for changing the test sheet to a new sheet 9 having a different thickness.

For example, the main control portion 8a executes processing of causing the display device 802 to display a message that prompts to set a sheet 9 having a different thickness in the sheet storing portion 1, and inputting new test thickness data via the operation device 801.

Furthermore, when the image processing apparatus 10 includes a plurality of sheet storing portions 1 for storing the sheets 9 having different thicknesses, the main control portion 8a may switch a supply source of the plurality of test sheets by the sheet conveying device 3.

After executing the processing of Step S111, the main control portion 8a shifts the processing to Step S101. Thus, the processing of Step S101 and subsequent steps is executed for the new test sheet having a different thickness.

### Step S112

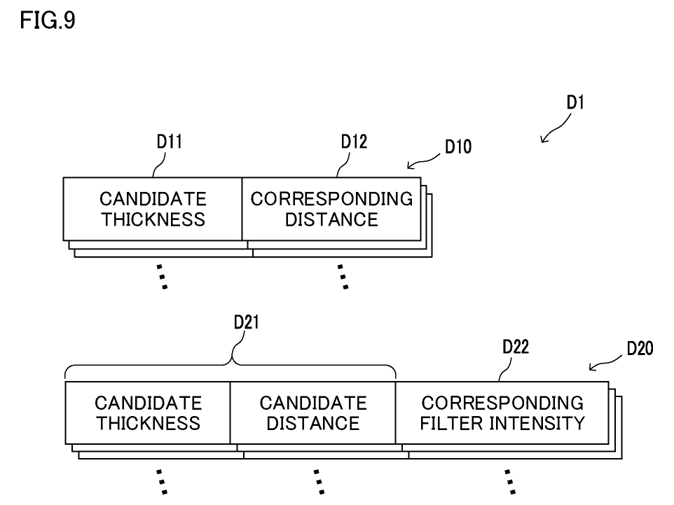

On the other hand, in Step S112, the main control portion 8a sets data corresponding to the test thickness in the registration data D1 in accordance with a result of the determination on the test image quality, and stores the set data in the secondary storage device 82 (see FIGS. 4 and 9).

The registration data D1 includes first correspondence data D10 and second correspondence data D20 (see FIG. 9).

The first correspondence data D10 represents a correspondence relationship between the plurality of candidate thicknesses and a plurality of corresponding distances. Each of the plurality of corresponding distances corresponds to one of the plurality of candidate distances. The first correspondence data D10 is data with which the corresponding unit distance can be specified for each of the plurality of candidate thicknesses.

In the example shown in FIG. 9, the first correspondence data D10 includes a plurality of pieces of candidate thickness data D11 and a plurality of pieces of corresponding distance data D12 associated with the plurality of pieces of candidate thickness data D11.

The plurality of pieces of candidate thickness data D11 represent the plurality of candidate thicknesses. The plurality of pieces of corresponding distance data D12 represent the plurality of corresponding distances.

The second correspondence data D20 represents a correspondence relationship between each of a plurality of combinations of the plurality of candidate thicknesses and the plurality of candidate distances and a plurality of corresponding parameters. Each of the plurality of corresponding parameters corresponds to one of the plurality of candidate parameters. The second correspondence data D20 is data with which a corresponding filter intensity can be specified for each of the combinations of the plurality of candidate thicknesses and the plurality of candidate distances.

In the example shown in FIG. 9, the second correspondence data D20 includes a plurality of pieces of candidate combination data D21 and a plurality of pieces of corresponding filter intensity data D22 associated with the plurality of pieces of candidate combination data D21.

The plurality of pieces of candidate combination data D21 represent the plurality of combinations of the plurality of candidate thicknesses and the plurality of candidate distances. Each of the plurality of pieces of corresponding filter intensity data D22 represents one of the plurality of candidate filter intensities.

The main control portion 8a sets data representing the plurality of candidate thicknesses adopted as the test thickness in Step S101 as the plurality of pieces of candidate thickness data D11.

Furthermore, the main control portion 8a sets the plurality of pieces of corresponding distance data D12 corresponding to the plurality of pieces of candidate thickness data D11. At that time, the main control portion 8a sets, as each of the plurality of pieces of corresponding distance data D12, data representing the test distance with which the most favorable determination result of the test image quality has been obtained out of the plurality of candidate distances adopted as the test distance in Step S102.

Furthermore, the main control portion 8a sets, as the plurality of pieces of candidate combination data D21, data representing the combinations of the plurality of candidate thicknesses and the plurality of candidate distances that have been adopted as the combination of the test thickness and the test distance in Step S101 and Step S102.

Furthermore, the main control portion 8a sets the plurality of pieces of corresponding filter intensity data D22 corresponding to the plurality of pieces of candidate combination data D21. At that time, the main control portion 8a sets, as each of the plurality of pieces of corresponding filter intensity data D22, data representing the test filter intensity with which the most favorable determination result of the test image quality has been obtained out of the plurality of candidate filters adopted as the test filter intensity in Step S105.

It is noted that the first correspondence data D10 may be data having a configuration different from that shown in FIG. 9, as long as it is data with which the corresponding unit distance can be specified for each of the plurality of candidate thicknesses.

Similarly, the second correspondence data D20 may be data having a configuration different from that shown in FIG. 9, as long as it is data with which the corresponding filter intensity can be specified for each of the combinations of the plurality of candidate thicknesses and the plurality of candidate distances.

After executing the processing of Step S112, the main control portion 8a ends the registration data setting processing.

### Print job control

Next, exemplary procedures of the print job control will be described with reference to the flowchart shown in FIG. 7.

The CPU 80 executes the print job control when job data, which is a request to execute the print job, is input via the communication device 84 or the operation device 801. The print job control is an example of processing for realizing the image processing apparatus control method.

Hereinafter, a case where a use of a plurality of types of sheets 9 with different thicknesses is required in the job data will be described.

In descriptions below, data representing the sheet thickness of each of the plurality of sheets 9 corresponding to the print job will be referred to as job thickness data. Each of the plurality of types of sheet thicknesses represented by the job thickness data is one of the plurality of candidate thicknesses. The job thickness data is included in the job data.

When the print job control is executed, the plurality of sheet storing portions 1 are storing the sheets 9 having the plurality of types of thicknesses represented by the job thickness data.

In descriptions below, S201, S202, ... represent identification codes of a plurality of steps in the print job control. In the print job control, processing of Step S201 is executed first.

### Step S201

In Step S201, the main control portion 8a acquires the job data via the communication device 84 or the operation device 801.

The job thickness data included in the job data is an example of data of a plurality of job sheet characteristics representing the sheet characteristics of each of the plurality of sheets 9 corresponding to the print job.

After executing the processing of Step S201, the main control portion 8a shifts the processing to Step S202.

### Step S202

In Step S202, the main control portion 8a specifies a representative thickness, which is one of the plurality of types of sheet thicknesses represented by the job thickness data. The representative thickness is an example of representative sheet characteristics.

For example, the main control portion 8a specifies a type with the largest number of print pages out of the plurality of types of sheet thicknesses represented by the job thickness data, as the representative thickness. Alternatively, the main control portion 8a may specify a type corresponding to the print of a first page out of the plurality of types of sheet thicknesses represented by the job thickness data, as the representative thickness.

After executing the processing of Step S202, the main control portion 8a shifts the processing to Step S203.

### Step S203

In Step S203, the main control portion 8a acquires the registration data D1 from the secondary storage device 82. After executing the processing of Step S203, the main control portion 8a shifts the processing to Step S204.

### Step S204

In Step S204, the main control portion 8a specifies a representative distance, which is the unit distance corresponding to the representative thickness, based on the first correspondence data D10 in the registration data D1. That is, the main control portion 8a specifies a distance represented by the data corresponding to the representative thickness out of the plurality of pieces of corresponding distance data D12 in the first correspondence data D10, as the representative distance.

After executing the processing of Step S204, the main control portion 8a shifts the processing to Step S205.

### Step S205

In Step S205, the main control portion 8a causes the unit support mechanism 7 to execute the operation of adjusting the unit distance to the representative distance. The processing of Step S205 is executed before the print job is executed.

After executing the processing of Step S205, the main control portion 8a shifts the processing to Step S206.

### Step S206

In Step S206, the main control portion 8a causes the printing device 2 to start the print job. Thus, the main control portion 8a causes the sheet conveying device 3 to execute the processing of sequentially conveying each of the plurality of sheets 9 along the conveying path 300. Furthermore, the main control portion 8a causes the image forming portion 4 to execute the processing of forming an image on each of the sheets 9 in the first area P1.

After executing the processing of Step S206, the main control portion 8a shifts the processing to Step S207.

The processing of Step S207 and subsequent steps is executed for each of the plurality of sheets 9 conveyed in the print job. In descriptions below, each of the plurality of sheets 9 will be referred to as a target sheet. Moreover, the sheet thickness of the target sheet will be referred to as a target thickness. The target thickness is an example of target sheet characteristics.

### Step S207

In Step S207, the main control portion 8a causes the filter processing portion 8c to execute processing of acquiring read image data RD1 for the output image with respect to the target sheet, that is obtained by the CIS unit 6.

After executing the processing of Step S207, the main control portion 8a shifts the processing to Step S208.

### Step S208

In Step S208, the main control portion 8a specifies a target filter intensity corresponding to the combination of the target thickness and the representative distance based on the second correspondence data D20 in the registration data D1, and sets the target filter intensity in the filter processing portion 8c.

The target filter intensity is a filter intensity represented by data corresponding to the combination of the target thickness and the representative distance out of the plurality of pieces of corresponding filter intensity data D22 of the second correspondence data D20. The target filter intensity is an example of a target parameter used in the sharpening filter processing with respect to the read image data RD1 obtained for the target sheet.

After executing the processing of Step S208, the main control portion 8a shifts the processing to Step S209.

### Step S209

In Step S209, the main control portion 8a causes the filter processing portion 8c to execute the sharpening filter processing that uses the target filter intensity with respect to the read image data RD1 for the target sheet. Thus, the processed image data corresponding to the target filter intensity is obtained.

After executing the processing of Step S209, the main control portion 8a shifts the processing to Step S210.

### Step S210

In Step S210, the image quality determination portion 8b determines the output image quality based on the processed image data corresponding to the target sheet. The output image quality is some or all of the density, position, and size of the output image with respect to the target sheet.

For example, the image quality determination portion 8b determines one or more of a density difference, a positional deviation amount, and a size difference as the output image quality. The density difference is a difference between the density of the output image and a target density. The positional deviation amount is an amount of deviation between the position of the output image and a target position. The size difference is a difference between the size of the output image and a target size.

After executing the processing of Step S210, the image quality determination portion 8b shifts the processing to Step S211.

### Step S211

In Step S211, the image quality determination portion 8b selects the next processing in accordance with whether or not the output image quality is outside a predetermined allowable range.

When the output image quality is outside the allowable range, the image quality determination portion 8b shifts the processing to Step S212. On the other hand, when the output image quality is within the allowable range, the image quality determination portion 8b shifts the processing to Step S213.

### Step S212

In Step S212, the main control portion 8a corrects the print parameter of the printing device 2 for the image formation on each of the sheets 9 conveyed after the target sheet, in accordance with the output image quality for the target sheet.

When the density difference is outside the allowable range, the main control portion 8a corrects the print density in the image forming portion 4. When the positional deviation amount is outside the allowable range, the main control portion 8a corrects the print position in the image forming portion 4. When the size difference is outside the allowable range, the main control portion 8a corrects the print size in the image forming portion 4.

Each of the print density, the print position, and the print size is an example of the print parameter.

After executing the processing of Step S212, the main control portion 8a shifts the processing to Step S213.

### Step S213

In Step S213, the main control portion 8a selects the next processing in accordance with whether or not the print job is ended.

When the print job is not yet ended, the main control portion 8a shifts the processing to Step S207. Thus, the processing of Step S207 and subsequent steps is executed for each of the subsequent sheets 9.

On the other hand, when the print job is ended, the main control portion 8a ends the print job control.

As described above, the CPU 80 executes the processing of acquiring the registration data D1 including the first correspondence data D10 and the second correspondence data D20 (see Step S203).

Furthermore, the CPU 80 also executes the processing of acquiring the job data including the job thickness data representing the sheet thickness of each of the plurality of sheets 9 corresponding to the print job (see Step S201).

Furthermore, the CPU 80 specifies the representative thickness, which is one of the sheet thicknesses of the plurality of sheets 9 corresponding to the print job (see Step S202).

Furthermore, before the print job is executed, the CPU 80 causes the unit support mechanism 7 to execute the operation of adjusting the unit distance to the representative distance corresponding to the representative thickness out of the plurality of candidate distances in the first correspondence data D10 (see Step S204 and Step S205).

Furthermore, the CPU 80 executes the processing of Step S208 every time the sharpening filter processing is executed on the read image data RD1 obtained for each of the plurality of sheets 9 conveyed in the print job (see Step S208 and Step S209).

In Step S208, the CPU 80 specifies the data of the target filter intensity corresponding to the combination of the target thickness and the representative distance from among the plurality of pieces of corresponding filter intensity data D22 in the second correspondence data D20.

Furthermore, in Step S208, the CPU 80 sets the target filter intensity in the filter processing portion 8c as the parameter to be used for the sharpening filter processing.

In the print job control, the adjustment of the unit distance corresponding to the representative thickness is performed before the print job is executed (see Step S201 to Step S205).

Furthermore, the read image data RD1 corresponding to each of the sheets 9 conveyed in the print job is subjected to the sharpening filter processing that uses the target filter intensity set according to the thickness of each of the sheets 9 (see Step S207 to Step S209).

That is, image blurring that occurs in the read image data RD1 due to a change in the sheet thickness during the print job is corrected by changing the filter intensity according to the sheet thickness.

Then, the processed image data in which the image blurring has been corrected is used to determine the output image quality (see Step S210).

Therefore, even when the plurality of types of sheets 9 having different sheet thicknesses are used in the print job, it is possible to avoid lowering of the image quality of the image read by the CIS unit 6 while maintaining the execution speed of the print job.

Incidentally, there is a fear that an appropriate content of the registration data D1 will be changed due to deterioration of the image processing apparatus 10 over time. Also, a user of the image processing apparatus 10 may find it difficult to take the time for the registration data setting processing.

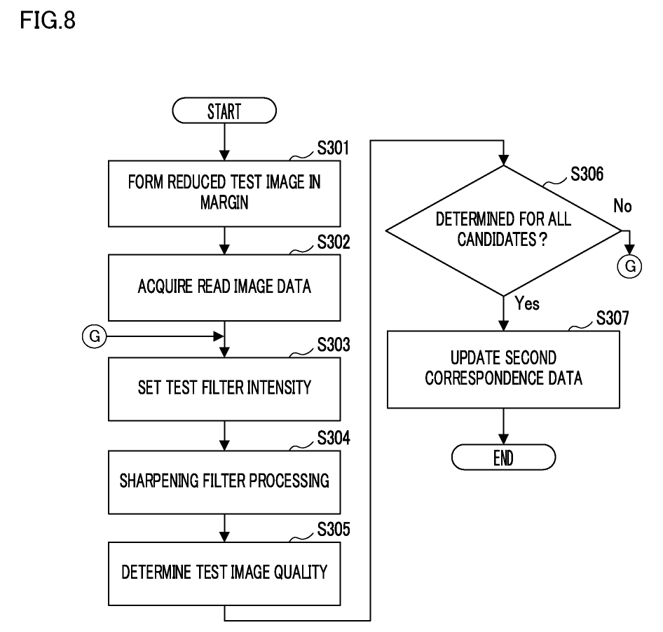

In this regard, the CPU 80 may execute registration data update processing in parallel with the print job control (see FIG. 8).

The registration data update processing is processing of forming a reduced test image in a margin area of some or all of the plurality of sheets 9 in the print job, and updating the second correspondence data D20 based on the read image data RD1 for the reduced test image.

The margin area is an area outside an area on the surface of each of the sheets 9 where an image is to be formed by the print job.

### Registration data update processing

Hereinafter, exemplary procedures of the registration data update processing will be described with reference to the flowchart shown in FIG. 8.

In descriptions below, some or all of the plurality of sheets 9 conveyed in the print job, that are to be subjected to the registration data update processing, will be referred to as sample sheets.

For example, the sample sheets are the sheets 9 that are conveyed for each predetermined number of sheets in the print job. The CPU 80 executes the registration data update processing every time the sample sheet is conveyed in the print job.

In descriptions below, S301, S302, ... represent identification codes of a plurality of steps in the registration data update processing. In the registration data update processing, processing of Step S301 is executed first.

### Step S301

In Step S301, the main control portion 8a causes the printing device 2 to execute processing of forming a reduced test image in a margin area of the target sheet. The reduced test image is an image obtained by reducing the test image formed in Step S103 in the registration data setting processing.

After executing the processing of Step S301, the main control portion 8a shifts the processing to Step S302.

### Step S302

In Step S302, the main control portion 8a causes the filter processing portion 8c to execute processing of acquiring the read image data RD1 for the image formed on the sample sheet, that is obtained by the CIS unit 6.

In descriptions below, image data of a portion of the reduced test image in the read image data RD1 will be referred to as test partial image data. After executing the processing of Step S302, the main control portion 8a shifts the processing to Step S303.

### Step S303

In Step S303, similar to Step S105, the main control portion 8a selects one test filter intensity from the plurality of candidate filter intensities, and sets the test filter intensity in the filter processing portion 8c.

After executing the processing of Step S303, the main control portion 8a shifts the processing to Step S304.

### Step S304

In Step S304, the main control portion 8a causes the filter processing portion 8c to execute the sharpening filter processing that uses the test filter intensity with respect to the test partial image data.

In Step S304, the processed image data of the test partial image data corresponding to the test filter intensity is obtained.

After executing the processing of Step S304, the main control portion 8a shifts the processing to Step S305.

### Step S305

In Step S305, similar to Step S107, the image quality determination portion 8b determines the test image quality of the processed image data obtained in Step S304.

After executing the processing of Step S305, the image quality determination portion 8b shifts the processing to Step S306.

### Step S306

In Step S306, the main control portion 8a selects the next processing in accordance with whether or not the determination on the test image quality has been performed for all of the plurality of candidate filter intensities.

When the determination on the test image quality has not been performed for some of the plurality of candidate filter intensities, the main control portion 8a shifts the processing to Step S303. Thus, a new test filter intensity is selected from the plurality of candidate filter intensities, and the processing of Step S303 and subsequent steps that corresponds to the new test filter intensity is executed.

On the other hand, when the determination on the test image quality has been performed for all of the plurality of candidate filter intensities, the main control portion 8a shifts the processing to Step S307.

### Step S307

In Step S307, the main control portion 8a updates the second correspondence data D20 in the registration data D1 in accordance with a result of the determination on the test image quality.

Specifically, the main control portion 8a specifies, as update target data, the corresponding filter intensity data D22 corresponding to the combination of the representative distance and the target thickness of the sample sheet in the second correspondence data D20.

As described above, the representative distance is the unit distance that is adjusted by the unit support mechanism 7 before the print job is started (see Step S204 and Step S205 in FIG. 7).

Furthermore, the main control portion 8a updates the update target data to data representing the test filter intensity with which a most favorable result of the determination on the test image quality has been obtained out of the plurality of candidate filters adopted as the test filter intensity in Step S303.

After executing the processing of Step S307, the main control portion 8a ends the registration data update processing.

As described above, the CPU 80 causes the printing device 2 to execute the processing of forming the reduced test image in the margin area of the sample sheet out of the plurality of sheets 9 conveyed in the print job (see Step S301).

Furthermore, the CPU 80 causes the filter processing portion 8c to execute the sharpening filter processing that uses each of the plurality of candidate parameters with respect to the test partial image data (see Step S303 and Step S304). The test partial image data is the read image data RD1 obtained for the margin area of the sample sheet.

Furthermore, the CPU 80 executes image quality evaluation for the processed image data obtained by the sharpening filter processing that uses each of the plurality of candidate parameters (see Step S305).

Furthermore, the CPU 80 updates the second correspondence data D20 for the combination of the target thickness of the sample sheet and the representative distance in the registration data D1, in accordance with a result of the image quality evaluation (see Step S307).

By executing the registration data update processing, the content of the registration data D1 is updated appropriately in accordance with the deterioration of the image processing apparatus 10 over time, and/or the like.

### Modified examples

In the embodiment described above, the sheet thickness is used as the sheet characteristics. Alternatively, a weight of each of the sheets 9 may be used as the sheet characteristics. For example, the weight of each of the sheets 9 is used as a characteristics value as an alternative for the sheet thickness of each of the sheets 9.

Furthermore, when both the sheet thickness and the weight are used, the weight may be converted into the sheet thickness using a predetermined conversion formula. Similarly, when both the sheet thickness and the weight are used, the sheet thickness may be converted into the weight.

Furthermore, a surface processed state of each of the sheets 9 may be used as the sheet characteristics. For example, an appropriate combination of the unit distance and the filter intensity differs between a case where the surface of each of the sheets 9 is coated with a brightening agent and a case where the surface is not coated with the brightening agent.

### Notes of disclosure

Hereinafter, a general outline of the disclosure extracted from the embodiment described above will be noted. It is noted that the respective configurations and processing functions described in the notes below can be sorted and arbitrarily combined as appropriate.

### Note 1

A image processing apparatus control method for controlling an image processing apparatus including
a printing device which executes a print job for conveying each of a plurality of sheets along a conveying path and forming an image on each of the plurality of sheets in a first area on the conveying path,
a contact image sensor unit which is arranged along a second area on a downstream side of the first area on the conveying path in a sheet conveying direction, and reads the image formed on each of the plurality of sheets,
a unit support mechanism which movably supports the contact image sensor unit and is capable of adjusting a unit distance which is a distance between the second area of the conveying path and the contact image sensor unit, and
a filter processing device which executes sharpening filter processing on read image data obtained by the contact image sensor unit, and outputs the processed image data,
the image processing apparatus control method including:
   acquiring, by a control device, first correspondence data representing a correspondence relationship between each of a plurality of candidate characteristics representing sheet characteristics and each of a plurality of corresponding distances corresponding to one of a plurality of candidate distances which are candidates for the unit distance, and second correspondence data representing a correspondence relationship between each of a plurality of combinations of the plurality of candidate characteristics and the plurality of candidate distances and each of a plurality of corresponding parameters corresponding to one of a plurality of candidate parameters which are candidates for a filter parameter;
   acquiring, by the control device, data of a plurality of job sheet characteristics representing the sheet characteristics of the plurality of sheets corresponding to the print job;
   specifying, by the control device, representative sheet characteristics as one of the plurality of job sheet characteristics;
   causing, by the control device, before the print job is executed, the unit support mechanism to execute an operation of adjusting the unit distance to a representative distance corresponding to the representative sheet characteristics out of the plurality of corresponding distances in the first correspondence data; and
   specifying, by the control device, every time the sharpening filter processing is executed on the read image data obtained for each of the plurality of sheets conveyed in the print job, a target parameter corresponding to a combination of target sheet characteristics corresponding to each of the plurality of sheets out of the plurality of job sheet characteristics and the representative distance, from among the plurality of candidate parameters in the second correspondence data, and setting the target parameter in the filter processing device as a parameter to be used for the sharpening filter processing.

### Note 2

The image processing apparatus control method according to note 1, including:
causing, by the control device, the printing device to execute processing of forming a test image in a margin area of a sample sheet out of the plurality of sheets conveyed in the print job;
causing, by the control device, the filter processing device to execute the sharpening filter processing that uses each of the plurality of candidate parameters with respect to the read image data obtained for the margin area of the sample sheet;
executing, by the control device, image quality evaluation for the processed image data obtained by the sharpening filter processing that uses each of the plurality of candidate parameters; and
updating, by the control device, data corresponding to a combination of the target sheet characteristics of the sample sheet and the representative distance in the second correspondence data, in accordance with a result of the image quality evaluation.

### Note 3

The image processing apparatus control method according to note 1 or 2, including:
acquiring, by the control device, data of test sheet characteristics representing the sheet characteristics of a plurality of test sheets having same characteristics;
causing, by the control device, the printing device to execute processing of conveying each of the plurality of test sheets along the conveying path, and forming the test image on each of the plurality of test sheets;
causing, by the control device, the unit support mechanism to execute an operation of adjusting the unit distance to a test distance sequentially selected from the plurality of candidate distances every time each of the plurality of test sheets is conveyed;
causing, by the control device, the filter processing device to execute the sharpening filter processing that uses each of the plurality of candidate parameters with respect to the read image data obtained for each of the plurality of test sheets;
determining, by the control device, test image quality for the processed image data obtained by the sharpening filter processing that uses each of the plurality of candidate parameters; and
setting, by the control device, data corresponding to the test sheet characteristics in the first correspondence data and the second correspondence data in accordance with a result of the determination on the test image quality.

### Note 4

The image processing apparatus control method according to any one of notes 1 to 3, in which
the sheet characteristics include one or more out of a thickness, a weight, and a surface processed state.

### Note 5

The image processing apparatus control method according to any one of notes 1 to 4, including:
determining, by the control device, output image quality which is some or all of a density, position, and size of an output image based on the processed image data obtained for the print job; and
correcting, by the control device, a print parameter of the printing device in accordance with a result of the determination on the output image quality.

### Note 6

An image processing apparatus, including:
a printing device which executes a print job for conveying each of a plurality of sheets along a conveying path and forming an image on each of the plurality of sheets in a first area on the conveying path;
a contact image sensor unit which is arranged along a second area on a downstream side of the first area on the conveying path in a sheet conveying direction, and reads the image formed on each of the plurality of sheets;
a unit support mechanism which movably supports the contact image sensor unit and is capable of adjusting a unit distance which is a distance between the second area of the conveying path and the contact image sensor unit;
a filter processing device which executes sharpening filter processing on read image data obtained by the contact image sensor unit, and outputs the processed image data; and
a control device which realizes the image processing apparatus control method according to any one of notes 1 to 5.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A image processing apparatus control method for controlling an image processing apparatus including
a printing device which executes a print job for conveying each of a plurality of sheets along a conveying path and forming an image on each of the plurality of sheets in a first area on the conveying path,
a contact image sensor unit which is arranged along a second area on a downstream side of the first area on the conveying path in a sheet conveying direction, and reads the image formed on each of the plurality of sheets,
a unit support mechanism which movably supports the contact image sensor unit and is capable of adjusting a unit distance which is a distance between the second area of the conveying path and the contact image sensor unit, and
a filter processing device which executes sharpening filter processing on read image data obtained by the contact image sensor unit, and outputs the processed image data,
the image processing apparatus control method comprising:
acquiring, by a control device, first correspondence data representing a correspondence relationship between each of a plurality of candidate characteristics representing sheet characteristics and each of a plurality of corresponding distances corresponding to one of a plurality of candidate distances which are candidates for the unit distance, and second correspondence data representing a correspondence relationship between each of a plurality of combinations of the plurality of candidate characteristics and the plurality of candidate distances and each of a plurality of corresponding parameters corresponding to one of a plurality of candidate parameters which are candidates for a filter parameter;
acquiring, by the control device, data of a plurality of job sheet characteristics representing the sheet characteristics of the plurality of sheets corresponding to the print job;
specifying, by the control device, representative sheet characteristics as one of the plurality of job sheet characteristics;
causing, by the control device, before the print job is executed, the unit support mechanism to execute an operation of adjusting the unit distance to a representative distance corresponding to the representative sheet characteristics out of the plurality of corresponding distances in the first correspondence data; and
specifying, by the control device, every time the sharpening filter processing is executed on the read image data obtained for each of the plurality of sheets conveyed in the print job, a target parameter corresponding to a combination of target sheet characteristics corresponding to each of the plurality of sheets out of the plurality of job sheet characteristics and the representative distance, from among the plurality of candidate parameters in the second correspondence data, and setting the target parameter in the filter processing device as a parameter to be used for the sharpening filter processing.

2. The image processing apparatus control method according to claim 1, comprising:
causing, by the control device, the printing device to execute processing of forming a test image in a margin area of a sample sheet out of the plurality of sheets conveyed in the print job;
causing, by the control device, the filter processing device to execute the sharpening filter processing that uses each of the plurality of candidate parameters with respect to the read image data obtained for the margin area of the sample sheet;
executing, by the control device, image quality evaluation for the processed image data obtained by the sharpening filter processing that uses each of the plurality of candidate parameters; and
updating, by the control device, data corresponding to a combination of the target sheet characteristics of the sample sheet and the representative distance in the second correspondence data, in accordance with a result of the image quality evaluation.

3. The image processing apparatus control method according to claim 1, comprising:
acquiring, by the control device, data of test sheet characteristics representing the sheet characteristics of a plurality of test sheets having same characteristics;
causing, by the control device, the printing device to execute processing of conveying each of the plurality of test sheets along the conveying path, and forming a test image on each of the plurality of test sheets;
causing, by the control device, the unit support mechanism to execute an operation of adjusting the unit distance to a test distance sequentially selected from the plurality of candidate distances every time each of the plurality of test sheets is conveyed;
causing, by the control device, the filter processing device to execute the sharpening filter processing that uses each of the plurality of candidate parameters with respect to the read image data obtained for each of the plurality of test sheets;
determining, by the control device, test image quality for the processed image data obtained by the sharpening filter processing that uses each of the plurality of candidate parameters; and
setting, by the control device, data corresponding to the test sheet characteristics in the first correspondence data and the second correspondence data in accordance with a result of the determination on the test image quality.

4. The image processing apparatus control method according to claim 1, wherein
the sheet characteristics include one or more out of a thickness, a weight, and a surface processed state.

5. The image processing apparatus control method according to claim 1, comprising:
determining, by the control device, output image quality which is some or all of a density, position, and size of an output image based on the processed image data obtained for the print job; and
correcting, by the control device, a print parameter of the printing device in accordance with a result of the determination on the output image quality.

6. An image processing apparatus, comprising:
a printing device which executes a print job for conveying each of a plurality of sheets along a conveying path and forming an image on each of the plurality of sheets in a first area on the conveying path;
a contact image sensor unit which is arranged along a second area on a downstream side of the first area on the conveying path in a sheet conveying direction, and reads the image formed on each of the plurality of sheets;
a unit support mechanism which movably supports the contact image sensor unit and is capable of adjusting a unit distance which is a distance between the second area of the conveying path and the contact image sensor unit;
a filter processing device which executes sharpening filter processing on read image data obtained by the contact image sensor unit, and outputs the processed image data; and
a control device which realizes the image processing apparatus control method according to claim 1.
